(19) United States
(12) Patent Application Publication
(10) Pub. No.: US 2020/0071929 A1
(43) Pub. Date: Mar. 5, 2020

(54) ROLLER PARTITION WALL

(71) Applicants: Jer-Shyh Chen, Taipei (TW); Jack Chen, Taipei (TW); Henry Chen, Taipei (TW)

(72) Inventors: Jer-Shyh Chen, Taipei (TW); Jack Chen, Taipei (TW); Henry Chen, Taipei (TW)

(21) Appl. No.: 16/551,571

(22) Filed: Aug. 26, 2019

(30) Foreign Application Priority Data
Aug. 30, 2018 (TW) 107211845

(51) Int. Cl. E04B 2/74; E05D 15/16

(52) U.S. Cl. CPC E04B 2/7453; E05Y 2900/142; E05D 15/165

(57) ABSTRACT

A roller partition wall comprises a ceiling bracket, a floor bracket, a partition wall, and a plurality of rollers. A bottom surface of the ceiling bracket forms a first sliding slot, a top surface of the floor bracket forms a second sliding slot corresponding to the first sliding slot, a top surface and a bottom surface of the partition wall are respectively inserted into the first sliding slot and the second sliding slot, and the partition wall is capable of movably disposing between the first sliding slot and the second sliding slot. The rollers are disposed in the second sliding slot and are between the partition wall and the second sliding slot. Since the partition wall is disposed between the ceiling bracket and the floor bracket, the partition wall can be moved left and right between the ceiling bracket and the floor bracket during shaking in an earthquake.

### BACKGROUND OF THE INVENTION

### Field of Invention

This present invention relates to a partition wall, and more particularly to a roller partition wall with anti-seismic function.

### Related Art

In the past, when construction companies built a house, each compartment of the house was usually completed during the construction. However, after the house owner purchased the house, the configuration of the compartments originally built by the construction company is often dissatisfied by the owner, and construction workers are hired to demolish the original compartments and reconstruct new ones. Nevertheless, the original compartments must be demolished first before using construction techniques for rebuilding the compartments with building materials such as bricks and cement, this method usually costs more time and money, and therefore, it is not the most suitable construction method. Thus, there is a compartment device called partition wall being introduced to the market. The construction technology of this device uses simple brackets, sidings and screws to fix the partition walls at desired positions of partitioning, which greatly reduces the construction time and cost, thereby reducing burden of the house owners, and allowing reconfiguration of the indoor compartments according to their preferences.

However, since the components of the partition wall are only simple brackets, sidings and screws, once earthquake comes, cracks and breakage of the partition wall are often caused by the strong shaking of the house, so such as slide rail partition wall of Taiwan utility model with publication M433430 was disclosed, comprising a ceiling bracket with a first sliding slot formed on a bottom surface thereof, a floor bracket with a second sliding slot formed on a top surface thereof, and a partition wall, wherein a top surface of the partition wall is aligned with the first sliding slot of the bottom surface of the ceiling bracket and is slidably disposed therein, and a bottom surface of the partition wall is aligned with the second sliding slot of the top surface of the floor bracket and is slidably disposed therein. Since the partition wall is slidably disposed on the ceiling bracket and the floor bracket, the partition wall can slide between the ceiling bracket and the floor bracket during shaking of earthquake. The sliding process disperses the shaking force generated by the earthquake on the partition wall, thereby protecting the partition wall from cracks and even breakage.

However, because the partition wall itself has a certain weight and is sandwiched between the ceiling and the floor, the friction generated by the sliding during an earthquake is large, and in the process of movement during the earthquake, it is inevitable that damage as well as noise generated by the friction will occur. In addition, it is also easy to cause a situation in which the partition wall cannot be restored to its position because of the large frictional force during the movement.

Therefore, the prior art slide rail partition wall has the problems and drawbacks as described above in the overall structure, which need to be improved.

### SUMMARY OF THE INVENTION

In view of the drawbacks and deficiencies of the prior art, the present invention provides a roller partition wall which can be moved left and right between a ceiling bracket and a floor bracket during shaking of an earthquake, thereby the shaking force generated by the earthquake on the partition wall can be dispersed by the movement process to avoid cracks or even breakage to the partition wall, and can be restored at any time when the earthquake stops.

In order to achieve the above-mentioned objects, the technical means adopted by the present invention is to design a roller partition wall, comprising:

a ceiling bracket having a bottom surface formed with a first sliding slot;

a floor bracket having a top surface formed with a second sliding slot corresponding to the first sliding slot;

a partition wall with a top surface and a bottom surface respectively disposed into the first sliding slot of the ceiling bracket and the second sliding slot of the floor bracket, causing the partition wall to be capable of movably disposing between the first sliding slot and the second sliding slot; and

a plurality of rollers capable of rollingly disposing in the second sliding slot, and between the partition wall and the second sliding slot, each of the rollers maintaining a certain distance from another roller.

The advantage of the present invention is that by having a bottom surface of a ceiling bracket formed with a first sliding slot; a top surface of a floor bracket formed with a second sliding slot corresponding to the first sliding slot; a top surface and a bottom surface of a partition wall respectively inserted into the first sliding slot of the ceiling bracket and the second sliding slot of the floor bracket, and the partition wall capable of movably disposing between the first sliding slot and the second sliding slot; therefore during shaking in an earthquake, the partition wall can be moved left and right between the ceiling bracket and the floor bracket along with the earthquake, thereby the shaking force generated by the earthquake on the partition wall can be dispersed by the movement process to avoid cracks or even breakage to the partition wall, and can be restored at any time when the earthquake stops.

Further, the roller partition wall, wherein each of the rollers is a solid cylinder with two end faces.

Further, the roller partition wall, wherein the first sliding slot comprises a first top panel and two first side panels, and the two first side panels extend downward from two opposite sides of the first top panel; the second sliding slot comprises a second top panel and two second side panels, and the two second side panels extend upward from two opposite sides of the second top panel.

Further, the roller partition wall, wherein the partition wall further comprises an upper fixing strip capable of movably disposing in the first sliding slot; a lower fixing strip corresponding to the upper fixing strip and capable of movably disposing in the second sliding slot; a plurality of upright posts mounted side by side between the upper fixing strip and the lower fixing strip; and two wall panels respectively fixed on two common opposite sides of the upright posts and on the upper fixing strip and the lower fixing strip.

Further, the roller partition wall, wherein depths of the first sliding slot and the second sliding slot are smaller than heights of the upper fixing strip and the lower fixing strip.

Further, the roller partition wall, wherein upper and lower edges of each of the wall panels are respectively fixedly disposed on outer sides of the upper fixing strip and the lower fixing strip.

### BRIEF DESCRIPTION OF THE DRAWINGS

FIG. 1 is a perspective view of a roller partition wall of the present invention;

FIG. 2 is an exploded view of the roller partition wall of the present invention;

FIG. 3 is a partial enlarged view of the roller partition wall of the present invention;

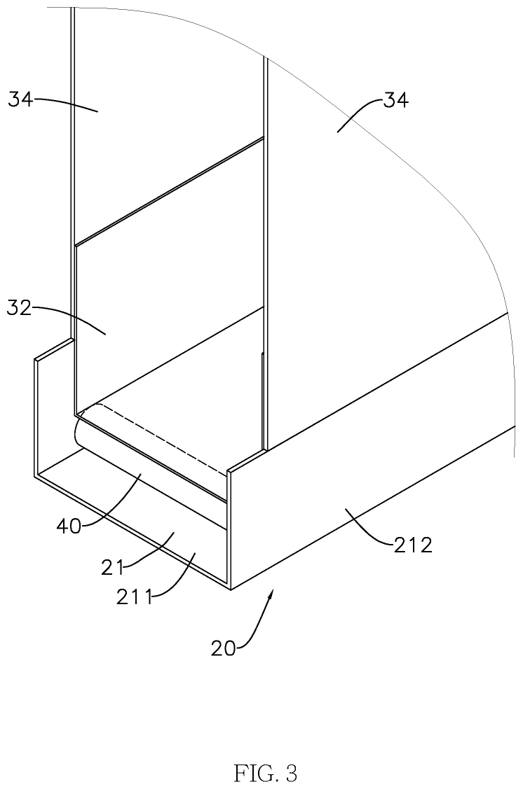

FIG. 4 is a top perspective view of the roller partition wall of the present invention; and

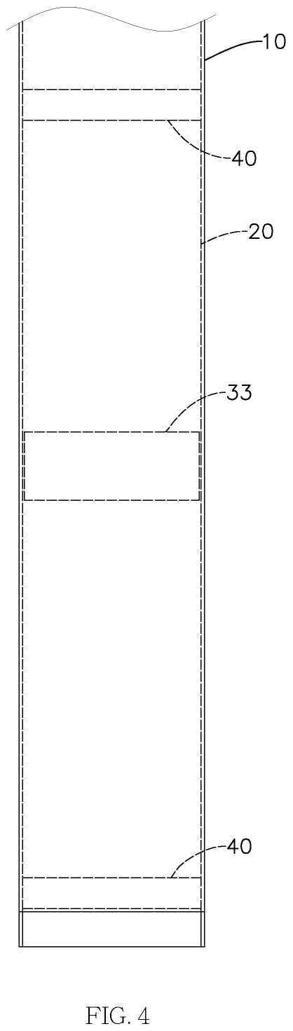

FIG. 5 is a schematic diagram of the action of the roller partition wall of the present invention.

### DETAILED DESCRIPTION OF THE INVENTION

The technical means adopted by the present invention for achieving the intended objects of present invention is further explained below in conjunction with the drawings and the preferred embodiments of the present invention.

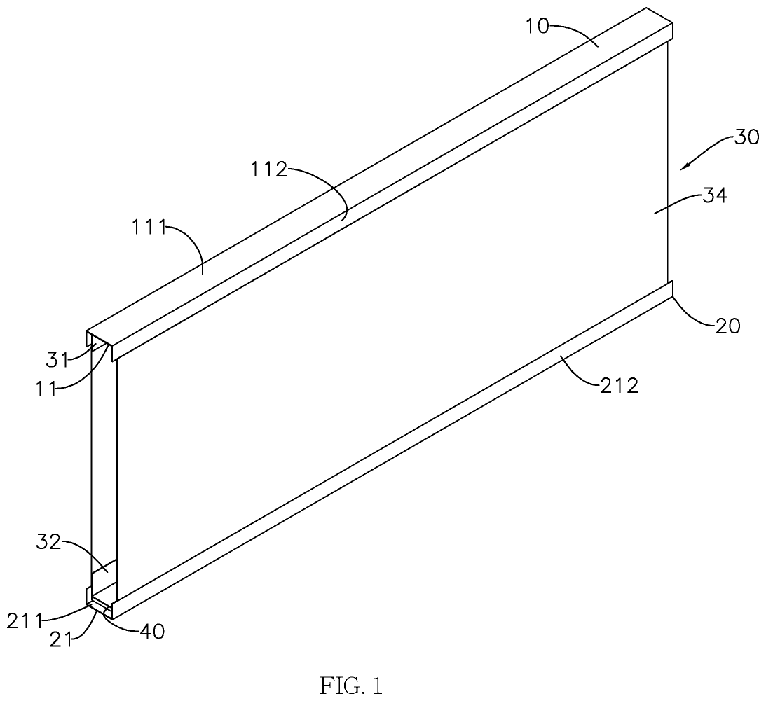

Please refer to FIG. 1, a roller partition wall 30 of the present invention comprises a ceiling bracket 10, a floor bracket 20, a partition wall 30 and a plurality of rollers 40.

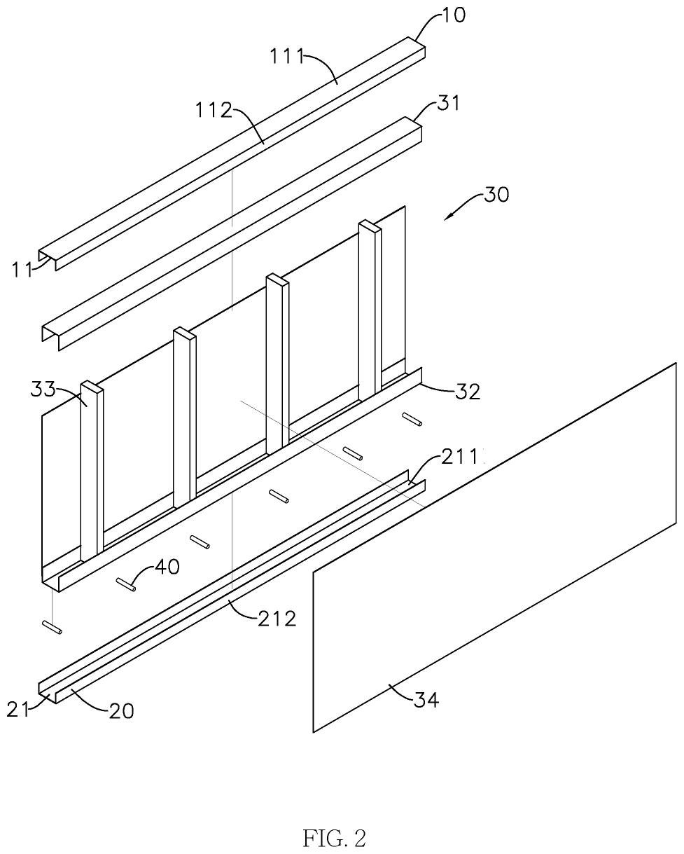

As shown in FIG. 1 and FIG. 2, a bottom surface of the ceiling bracket 10 is formed with a first sliding slot 11. In this embodiment, the first sliding slot 11 comprises a first top panel 111 and two first side panels 112. The two first side panels 112 extend downward from two opposite sides of the first top panel 111. In other words, a cross-section of the first sliding slot 11 is a structure similar to an inverted U-shape.

A top surface of the floor bracket 20 is formed with a second sliding slot 21 corresponding to the first sliding slot 11. In this embodiment, the second sliding slot 21 comprises a second top panel 211 and two second side panels 212. The two second side panels 212 extend upward from two opposite sides of the second top panel 211. In other words, a cross-section of the second sliding slot 21 is a structure similar to a U-shape.

A top surface and a bottom surface of the partition wall 30 are respectively inserted into the first sliding slot 11 of the ceiling bracket 10 and the second sliding slot 21 of the floor bracket 20, so that the partition wall 30 is capable of movably disposing between the first sliding slot 11 and the second sliding slot 21. In this embodiment, the partition wall 30 comprises an upper fixing strip 31 capable of movably disposing in the first sliding slot 11, and a depth of the first sliding slot 11 is smaller than a height of the upper fixing strip 31; a lower fixing strip 32 corresponding to the upper fixing strip 31 and capable of movably disposing in the second sliding slot 21, and a depth of the second sliding slot 21 is smaller than a height of the lower fixing strip 32; a plurality of upright posts 33 mounted side by side and equally spaced apart between the upper fixing strip 31 and the lower fixing strip 32, and perpendicularly to the upper fixing strip 31 and the lower fixing strip 32; and two wall panels 34 respectively fixed on two common opposite sides of the upright posts 33 and on the upper fixing strip 31 and the lower fixing strip 32. In this embodiment, upper and lower edges of each of the wall panels 34 are respectively fixedly disposed on outer sides of the upper fixing strip 31 and the lower fixing strip 32, and outer surfaces of the two wall panels 34 are respectively flush with outer surfaces of the two second side panels 212.

The rollers 40 are capable of rollingly disposing in the second sliding slot 21, and between the partition wall 30 and the second sliding slot 21, and each of the rollers 40 maintains a certain distance from another roller 40. In this embodiment, the roller 40 is a solid cylinder with two end faces, but is not limited thereto, and can be other objects with a rolling function. The rollers 40 are placed in the second sliding slot 21, and the two end faces are respectively parallel to the second side panels 212 of the second sliding slot 21, or a center of rotation of each of the rollers 40 is perpendicular to the second side panels 212 of the floor bracket 20, and are maintained at a specific distance so that the rollers 40 can be smoothly disposed in the second sliding slot 21 and can roll along directions extended from two ends of the second sliding slot 21.

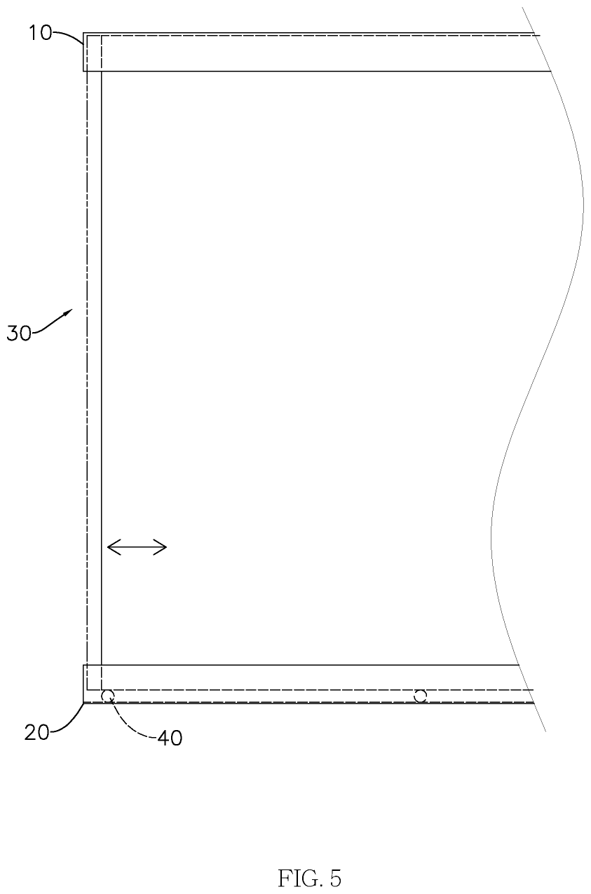

Please refer to FIG. 5, since the top surface and the bottom surface of the partition wall 30 are capable of movably disposing between the first sliding slot 11 of the ceiling bracket 10 and the second sliding slot 21 of the floor bracket 20, during shaking in an earthquake, the rollers 40 in the second sliding slot 21 can be used to cause the partition wall 30 to move between the ceiling bracket 10 and the floor bracket 20; and thereby the pressing force generated by the earthquake on the partition wall 30 can be dispersed by the movement process in order to protect the partition wall 30 from damage.

In the foregoing process, since the rolling rollers 40 are used as a medium for moving the partition wall 30, the rolling method not only can reduce the frictional resistance, but also can reduce the noise generated during the movement.

The above description is only preferred embodiments of the present invention, and is not intended to limit the present invention in any way. Although the present invention has been disclosed above by the preferred embodiments, they are not intended to limit the present invention. Any person having ordinary skill in the art can make s changes or modifications to the above-disclosed technical contents to become equivalent embodiments without departing from the scope of the technical solutions of the present invention. Any simple alterations, equivalent changes and modifications made substantially to the above embodiments in accordance with the techniques of the present invention still fall within the scope covered by the appended claims of the present invention.

What is claimed is:

1. A roller partition wall, comprising:
a ceiling bracket having a bottom surface formed with a first sliding slot;
a floor bracket having a top surface formed with a second sliding slot corresponding to the first sliding slot;
a partition wall with a top surface and a bottom surface respectively disposed into the first sliding slot of the ceiling bracket and the second sliding slot of the floor bracket, causing the partition wall to be capable of movably disposing between the first sliding slot and the second sliding slot; and
a plurality of rollers capable of rollingly disposing in the second sliding slot, and between the partition wall and the second sliding slot, each of the rollers maintaining a certain distance from another roller.

2. The roller partition wall as claimed in claim 1, wherein each of the rollers is a solid cylinder with two end faces.

3. The roller partition wall as claimed in claim 1, wherein the first sliding slot comprises a first top panel and two first side panels, and the two first side panels extend downward from two opposite sides of the first top panel, the second sliding slot comprises a second top panel and two second side panels, and the two second side panels extend upward from two opposite sides of the second top panel.

4. The roller partition wall as claimed in claim 2, wherein the first sliding slot comprises a first top panel and two first side panels, and the two first side panels extend downward from two opposite sides of the first top panel, the second sliding slot comprises a second top panel and two second side panels, and the two second side panels extend upward from two opposite sides of the second top panel.

5. The roller partition wall as claimed in claim 1, wherein the partition wall further comprises:
an upper fixing strip capable of movably disposing in the first sliding slot;
a lower fixing strip corresponding to the upper fixing strip and capable of movably disposing in the second sliding slot;
a plurality of upright posts mounted side by side between the upper fixing strip and the lower fixing strip; and
two wall panels respectively fixed on two common opposite sides of the upright posts and on the upper fixing strip and the lower fixing strip.

6. The roller partition wall as claimed in claim 2, wherein the partition wall further comprises:
an upper fixing strip capable of movably disposing in the first sliding slot;
a lower fixing strip corresponding to the upper fixing strip and capable of movably disposing in the second sliding slot;
a plurality of upright posts mounted side by side between the upper fixing strip and the lower fixing strip; and
two wall panels respectively fixed on two common opposite sides of the upright posts and on the upper fixing strip and the lower fixing strip.

7. The roller partition wall as claimed in claim 3, wherein the partition wall further comprises:
an upper fixing strip capable of movably disposing in the first sliding slot;
a lower fixing strip corresponding to the upper fixing strip and capable of movably disposing in the second sliding slot;
a plurality of upright posts mounted side by side between the upper fixing strip and the lower fixing strip; and
two wall panels respectively fixed on two common opposite sides of the upright posts and on the upper fixing strip and the lower fixing strip.

8. The roller partition wall as claimed in claim 4, wherein the partition wall further comprises:
an upper fixing strip capable of movably disposing in the first sliding slot;
a lower fixing strip corresponding to the upper fixing strip and capable of movably disposing in the second sliding slot;
a plurality of upright posts mounted side by side between the upper fixing strip and the lower fixing strip; and
two wall panels respectively fixed on two common opposite sides of the upright posts and on the upper fixing strip and the lower fixing strip.

9. The roller partition wall as claimed in claim 6, wherein depths of the first sliding slot and the second sliding slot are smaller than heights of the upper fixing strip and the lower fixing strip.

10. The roller partition wall as claimed in claim 5, wherein depths of the first sliding slot and the second sliding slot are smaller than heights of the upper fixing strip and the lower fixing strip.

11. The roller partition wall as claimed in claim 7, wherein depths of the first sliding slot and the second sliding slot are smaller than heights of the upper fixing strip and the lower fixing strip.

12. The roller partition wall as claimed in claim 8, wherein depths of the first sliding slot and the second sliding slot are smaller than heights of the upper fixing strip and the lower fixing strip.

13. The roller partition wall as claimed in claim 9, wherein upper and lower edges of each of the wall panels are respectively fixedly disposed on outer sides of the upper fixing strip and the lower fixing strip.

14. The roller partition wall as claimed in claim 10, wherein upper and lower edges of each of the wall panels are respectively fixedly disposed on outer sides of the upper fixing strip and the lower fixing strip.

15. The roller partition wall as claimed in claim 11, wherein upper and lower edges of each of the wall panels are respectively fixedly disposed on outer sides of the upper fixing strip and the lower fixing strip.

16. The roller partition wall as claimed in claim 12, wherein upper and lower edges of each of the wall panels are respectively fixedly disposed on outer sides of the upper fixing strip and the lower fixing strip.
